(19) United States
(12) Patent Application Publication
(10) Pub. No.: US 2014/0265435 A1
(43) Pub. Date: Sep. 18, 2014

(54) BUMPER WITH ENHANCED COOLING AND ASSOCIATED DRAG REDUCTION DEVICE

(71) Applicant: PACCAR Inc, Bellevue, WA (US)

(72) Inventor: Jeffrey P. Smith, Prosper, TX (US)

(73) Assignee: PACCAR Inc, Bellevue, WA (US)

(21) Appl. No.: 14/206,705

(22) Filed: Mar. 12, 2014

Related U.S. Application Data
(60) Provisional application No. 61/777,478, filed on Mar. 12, 2013.

(51) Int. Cl. B62D 35/00

(52) U.S. Cl. CPC B62D 35/001
USPC 296/180.2

(57) ABSTRACT

An air dam is configured to improve the aerodynamic characteristics of a vehicle. The air dam includes a vertically extending component that extends downward from an area below a front bumper of the vehicle. The air dam further includes a horizontally extending component that extends forward from an upper end of the vertically extending component to an area located forward of a leading edge of the bumper.

### CROSS-REFERENCES TO RELATED APPLICATIONS

This application claims the benefit of U.S. Provisional Application No. 61/777,478, filed Mar. 12, 2013, the disclosure of which is incorporated by reference herein.

### BACKGROUND

Motor vehicles, and in particular trucks, are a critical component of the system for transporting materials, goods and people from place to place. The amount of energy required to move such vehicles depends on many factors. For instance, a substantial amount of energy is expended to overcome the resistance encountered in moving the vehicle through air. The amount of energy expended depends in large part on the aerodynamic drag force exerted on the vehicle by the air. A vehicle moving through air experiences a drag force, which may be divided into two components: frictional drag and pressure drag. Frictional drag comes from friction generated generally through the boundary layer as the vehicle passes through the air. Pressure drag results from the net pressure forces exerted as the air flows around the vehicle. A substantial component of the pressure drag is associated with the formation of a low pressure zone behind the vehicle, as evidenced by the formation of a wake behind the vehicle.

The distinction between frictional drag and pressure drag is useful because the two types of drag are due to different flow phenomena. Frictional drag is typically most important for attached flows—that is, where the flow boundary layer has not separated from the vehicle surfaces, and is related to the surface area exposed to the flow. Pressure drag dominates for separated flows, and is generally related to the cross-sectional area of the vehicle facing the air flow. When the drag on vehicle is dominated by pressure drag forces, it will expend far more energy traveling through air than the same vehicle dominated by friction drag forces. It is therefore advantageous in the design of a vehicle to reduce pressure drag forces; thereby increasing the aerodynamic properties and efficiency of the vehicle.

A bluff body, such as a conventional truck hood or front section, produces significant pressure drag at typical highway speeds. One reason for the large pressure drag is the presence of a sharp angle located at a leading edge of the truck hood. More specifically, typical truck front sections include a substantially vertical front surface or grill that meets, along an upper edge, a substantially horizontal top surface. The air flow passing over the front section, therefore, must negotiate an abrupt change in direction as the edge where the hood structure transitions from a substantially vertical orientation to a substantially horizontal orientation. This abrupt turn causes the flow to ‘separate’ from the top surface of the hood, forming a highly turbulent region of air located directly above the top surface of the hood, between the leading edge and the windshield.

Another reason for large pressure drag on a bluff body, such as a conventional truck front section, is the presence of a sharp angle located at a lower edge of the truck bumper and the passage of airflow underneath the vehicle and associated trailer. At highway speeds, such underbody air flow interacts with undercarriage components, such as wheel assemblies, skid plates, oil pans, transmission housings, drive shafts, chassis structure, etc., which in turn, develops a substantial amount of turbulent airflow in the underbody region of the vehicle and/or trailer.

To address such aerodynamic deficiencies caused by underbody air flow, air dams have been created to block the air flow. One example of a conventional air dam is shown in FIG. 10. As best shown in FIG. 10, the air dam D extends solely vertically from the bumper B to just proximal the road surface. Due to this design, however, several problems occur.

Thus, there exists a need, among others, for an aerodynamically designed front bumper section of a motor vehicle that mitigates drag forces imparted by underbody air flow.

### SUMMARY

A first exemplary embodiment of a disclosed air dam is configured to improve the aerodynamic characteristics of a vehicle. The air dam includes a vertically extending component that extends downward from an area below a front bumper of the vehicle. The air dam further includes a horizontally extending component that extends forward from an upper end of the vertically extending component to an area located forward of a leading edge of the bumper.

A second exemplary embodiment of an air dam includes a vertically extending component that extends downward from an area below a front bumper of the vehicle. The air dam further includes a horizontally extending component that extends forward from an upper end of the vertically extending component to an area located forward of a leading edge of the bumper. A second horizontally extending component extends in a rearward direction from a lower end of the vertically extending component.

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a front perspective view of one example of a front section of a vehicle employing one embodiment of an aerodynamic device in accordance with aspects of the present disclosure;

FIG. 2 is a top view of the vehicle of FIG. 1 employing one embodiment of an aerodynamic device;

FIG. 3 is a bottom perspective view of the vehicle of FIG. 1 employing one embodiment of an aerodynamic device;

FIG. 4 is a side view of the vehicle of FIG. 1 employing one embodiment of an aerodynamic device;

FIG. 5 is an air flow diagram of the vehicle depicted in FIG. 4;

FIG. 6 is a bottom perspective view of another example of a front section of a vehicle employing a second embodiment of an aerodynamic device in accordance with aspects of the present disclosure;

FIG. 7 is a top view of the vehicle of FIG. 6 employing a second embodiment of an aerodynamic device;

FIG. 8 is a front perspective view of the vehicle of FIG. 6 employing a second a second embodiment of an aerodynamic device; and

FIG. 9 is a side view of the vehicle of FIG. 6 employing a second embodiment of an aerodynamic device;

FIG. 10 is a side view of a conventional air dam mounted underneath a bumper of a vehicle.

### DETAILED DESCRIPTION

The detailed description set forth below in connection with the appended drawings, where like numerals reference like elements, is intended as a description of various embodiments of the disclosed subject matter and is not intended to represent the only embodiments. Each embodiment described in this disclosure is provided merely as an example or illustration and should not be construed as preferred or advantageous over other embodiments. The illustrative examples provided herein are not intended to be exhaustive or to limit the claimed subject matter to the precise forms disclosed.

The following discussion provides examples of systems and methods for improving the aerodynamic efficiency (e.g., reduce drag) on vehicles. Several embodiments of the present disclosure are directed to systems and methods that utilize one or more fairings, deflectors, vanes, fins, etc., on the front section of a vehicle for reducing the aerodynamic drag thereon. Non-limiting examples of vehicles that may benefit from the aerodynamic devices and methods of the present disclosure include but are not limited to light, medium, and heavy duty trucks, recreational and vocational vehicles, buses, etc., just to name a few. Although embodiments of the present disclosure will be described with reference to a Class 8 truck, one skilled in the relevant art will appreciate that the disclosed embodiments are illustrative in nature, and therefore, should not be construed as limited to applications with Class 8 trucks. It should therefore be apparent that the aerodynamic components and drag reducing methods of the present disclosure have wide application, and may be used in any situation where reducing the drag of any type of a vehicle is desirable.

In the following description, numerous specific details are set forth in order to provide a thorough understanding of exemplary embodiments of the present disclosure. It will be apparent to one skilled in the art, however, that many embodiments of the present disclosure may be practiced without some or all of the specific details. In some instances, well-known process steps have not been described in detail in order not to unnecessarily obscure various aspects of the present disclosure. Further, it will be appreciated that embodiments of the present disclosure may employ any combination of features described herein.

FIGS. 1-4 illustrate one example of an aerodynamic (e.g., drag reducing) component, generally denoted 100, in accordance with aspects of the present disclosure. As best shown in FIGS. 1 and 3, the component 100 includes one or more fairings or streamline surfaces mounted to or otherwise positioned beneath the front bumper of a vehicle, such as a Class 8 truck. Generally described, the aerodynamic (e.g., drag reducing) component 100 includes an air dam 120 that traverses laterally below the front bumper 64 of vehicle 20. It some embodiments, the air dam 120 may be integrally formed with the front bumper, if desired.

One suitable vehicle in which the aerodynamic component of the present disclosure may be employed will now be described in more detail with reference to FIGS. 1-4. Turning now to FIGS. 1-4, there is shown a vehicle 20 in the form of a heavy duty truck, employing one suitable embodiment of the aerodynamic component 100. The vehicle 20 depicted in FIGS. 1-4 represents one of the possible applications for the exemplary systems and methods of the present disclosure. It should be appreciated that aspects of the present disclosure transcend any particular type of vehicle.

As best shown in FIG. 1, the vehicle 20 comprises a chassis that is supported by wheels 22 connected thereto via conventional suspension assemblies (not shown). A front section 28 is supportably mounted on the chassis. The front section 28 generally includes a vertically oriented front surface or grille 32, an optional grille crown 36 that surrounds the vertical grille 32, and a generally horizontal hood 40 that generally covers a block-like shaped engine compartment housing.

The hood 40 extends rearwardly from an upper leading edge 42 of the grille crown 36 to the windshield 48 of a cab section. The front section 28 further includes fenders 56 that cover the wheels 22 and a bumper 64 that extends horizontally across the front of the vehicle 20 just beneath the vehicle grille 32 and fenders 56. In the embodiment shown, the bumper 64 includes a centralized opening 68 that permits air therethrough.

Referring now to FIGS. 2-4, there is shown one embodiment of the air dam 120 formed in accordance with aspects of the present disclosure. The air dam 120 is suitable for use with a vehicle, such as the vehicle 20, described above, or other vehicles such as passenger vehicles, motor homes, buses, etc., for improving the aerodynamic characteristics thereof. The air dam 120 or any combination of components hereinafter described may be installed on new vehicles or may be retrofitted on existing vehicles.

As best shown in FIGS. 2-4, the body 122 of the air dam 120 includes a generally vertically extending component 126 and a generally horizontally extending component 130. In some embodiments, the air dam 120 can be integrally formed out of any suitable material, such as lighter weight metal (e.g., aluminum, stamped steel, etc.), thermoplastics, etc., or any material currently utilized in the construction of vehicle fairings, deflectors, etc. As best shown in FIGS. 3 and 4, the vertically extending component 126 extends downwardly from a distal section of the horizontally extending component 130. The vertically extending component 126 defines a forwardly facing contact surface 134 having a curvature similar to that of the vehicle bumper 64. When the air dam 120 is installed on the vehicle 20, the contact surface 134 of the vertically extending component 126 is positioned aft of the general plane defined by the grille 32 and the front surface 70 of the vehicle bumper 64. Additionally, the generally horizontally extending component 130 extends forwardly of the top edge of the vertically extending component 126 and fore of the vehicle bumper 64 to a leading edge 140. In one embodiment, the shape of the leading edge 140 generally corresponds to the perimeter of the vehicle front section 28 as shown in the top view of FIG. 2. In the embodiment shown, the contact surface 134 of the generally vertically extending component 126 generally converges with the leading edge 140 of the generally horizontally extending component 130 at the lateral aft section of the air dam 120.

FIG. 5 is a side view of a front section 28 of a vehicle 20 employing one example of the air dam 120 and showing an air stream A flowing into the grille 32 and over the hood 40. The depicted air stream A encounters the front section of the vehicle 20 at the substantially vertical surface of the grille 32 and the front surface of the bumper 64. (It will be appreciated that for purposes of the present aerodynamic discussion, the vehicle's 20 forward motion at highway speeds is equivalent to an air stream A having a similar but opposite velocity flowing over a stationary vehicle.) The air stream A turns upwardly as it negotiates the grille 32, and separates at a leading edge of the hood 40, thereby forming a vortex or wake region W located aft of the leading edge.

The airflow A also impinges on the contact surface 134 of the vertically extending component 126 of the air dam 120, and is directed laterally outwardly with respect to the longitudinal axis of the vehicle, which in turn, aims to reduce drag on the vehicle from such components as the wheels 22 and other components associated with the undercarriage of the vehicle. In addition, the configuration and arrangement of the horizontally extending component 130 forces air through the centralized opening 68 of the bumper 64, which in turn, provides improved air flow through an associated cooling module positioned behind the bumper, in the engine compartment, etc.

FIGS. 6-9 illustrates another example of an air dam 220 formed in accordance with aspects of the present disclosure. The air dam 220 is shown mounted below the bumper 64 of the vehicle 20, described above. The air dam 220 is similar in materials, construction and operation as the air dam 120 except for the differences that will now be described in detail. As best shown in FIGS. 6-9, the vertically extending component 226 of the air dam 220 is positioned more forwardly of the wheels 22 as compared to air dam 120. In the embodiment shown, the contact surface 234 of the vertically extending component 226 is positioned slightly aft of the general plane defined by the grille 32 and bumper 64. Additional, the air dam 220 includes a bottom panel 240 that spans generally horizontally between the lateral edges of the vertically extending component 226, as best shown in FIG. 6. Further, the air dam 220 includes an area 260 of increased thickness in the vicinity of the bumper opening 68, as best shown in FIGS. 8 and 9. In one embodiment, the area 260 of increased thickness includes a ramp section 270 that functions to smooth the airflow into the centralized opening 68 of the bumper 64. In the embodiment shown, the ramp section 270 is generally rounded, as best shown in the side view of FIG. 9.

It should be noted that for purposes of this disclosure, terminology such as “upper,” “lower,” “vertical,” “horizontal,” “fore,” “aft,” “inner,” “outer,” “front,” “rear,” etc., should be construed as descriptive and not limiting the scope of the claimed subject matter. Further, the use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings.

The principles, representative embodiments, and modes of operation of the present disclosure have been described in the foregoing description. However, aspects of the present disclosure which are intended to be protected are not to be construed as limited to the particular embodiments disclosed. Further, the embodiments described herein are to be regarded as illustrative rather than restrictive. It will be appreciated that variations and changes may be made by others, and equivalents employed, without departing from the spirit of the present disclosure. Accordingly, it is expressly intended that all such variations, changes, and equivalents fall within the spirit and scope of the present disclosure, as claimed.

The embodiments of the invention in which an exclusive property or privilege is claimed are defined as follows:

1. An air dam for improving aerodynamic characteristics of a vehicle, the air dam comprising:
(a) a vertically extending component extending downward from an area below a front bumper of the vehicle; and
(b) a horizontally extending component extending forward from an upper end of the vertically extending component to an area located forward of a leading edge of the bumper.

2. The air dam of claim 1, wherein the vertically extending component extends laterally across the front of the vehicle.

3. The air dam of claim 1, wherein the horizontally extending component extends laterally across the front of the vehicle.

4. The air dam of claim 1, further comprising a second horizontally extending component extending rearward from a lower end of the vertically extending component.

5. An air dam positioned below the bumper of a vehicle, the air dam configured to improve the aerodynamic characteristics of the vehicle.

6. The air dam of claim 1, wherein the air dam is configured to direct air flow through a bumper opening to increase cooling capacity of an associated system.

7. Air dams as shown and described.

8. A combination air dam and front bumper as shown and described.

9. A combination air dam and front bumper, the air dam positioned below the bumper of a vehicle and configured to improve the aerodynamic characteristics of the vehicle.

10. The combination of claim 5, wherein the front bumper has a centralized opening, and where the air dam is configured to direct air flow through the centralized opening.
